(19) United States
(12) Patent Application Publication
(10) Pub. No.: US 2014/0114621 A1
(43) Pub. Date: Apr. 24, 2014

(54) Customizable Interactive System & Methods for Graphically Depicting Complex Facility Operations

(71) Applicants: Sean Brigandi, Larchmont, NY (US); Richard Budinich, Brooklyn, NY (US); John Mezic, Katonah, NY (US); Walter Pliszak, Morganville, NJ (US); Justin Redmond, Weehawken, NJ (US)

(72) Inventors: Sean Brigandi, Larchmont, NY (US); Richard Budinich, Brooklyn, NY (US); John Mezic, Katonah, NY (US); Walter Pliszak, Morganville, NJ (US); Justin Redmond, Weehawken, NJ (US)

(21) Appl. No.: 14/056,353

(22) Filed: Oct. 17, 2013

Related U.S. Application Data
(60) Provisional application No. 61/716,023, filed on Oct. 19, 2012.

(51) Int. Cl. G06F 17/50

(52) U.S. Cl. CPC G06F 17/5004
USPC 703/1

(57) ABSTRACT

The present invention relates to a novel customizable interactive building modeling system capable of graphically depicting complex facility operations. It is contemplated that the system according to the present invention will be used with mechanical, electrical, plumbing and fire protection (MEPFP) systems within, by way of example only, and without limitation, hospitals, commercial buildings, industrial buildings, residential buildings, educational buildings, entertainment complexes, data centers, large warehouses, large nursing homes, recreational centers, penal facilities, and governmental and other facilities. The present invention further contemplates the user's ability to utilize the graphic user interface associated with portable and battery operated devices, such as tablets and smartphones, to enjoy the features of this novel system. The present invention further contemplates uses in what are referred to as “complex facilities” such as, without limitation, facilities which include educational and commercial campuses, as well as governmental, commercial and residential infrastructures.

This application claims the benefit and filing priority of U.S. Provisional Patent Application No. 61/716,023 filed on Oct. 19, 2012.

### BACKGROUND OF THE INVENTION

### Introduction

The present invention relates generally to building modeling systems, and more particularly to a novel customizable interactive building modeling system capable of graphically depicting complex facility operations and infrastructure systems. It is contemplated that the system according to the present invention will be used with mechanical (i.e. heating, ventilation, air conditioning system), electrical (i.e. power distribution and controls), plumbing (i.e. domestic water, steam, and waste water, storm and sanitary) and fire protection (i.e. pre-action, sprinkler and fire alarm) (MEPFP) systems within, by way of example only, and without limitation, hospitals, commercial buildings, industrial buildings, residential buildings, educational buildings, entertainment complexes, data centers, large warehouses, large nursing homes, recreational centers, penal facilities, and governmental and other facilities. As used in this specification, the term “facility” is meant to include all types of facilities, buildings, and infrastructures of the type just mentioned. The present invention further contemplates the user's ability to utilize the graphic user interface associated with portable and battery operated devices, such as laptops, tablets and smartphones, by use of a standalone program, app or internet based interface to enjoy the features of this novel system.

As will be further elaborated upon below, currently, in facilities of the type described above, there are mechanical, electrical plumbing systems, and fire protection which require care, maintenance and modeling for safety and other reasons. In many cases, there is reliance by a facilities manager upon diagrams in which these systems are illustrated. Floorplans with circuit and infrastructure layouts and details are relied upon. Chilled water pipe diagrams picture their routing. The equipment itself is normally labeled, such as on electrical switchboards or on a panel schedule which is tucked away in a sleeve within the panel's trim. Then there is reliance upon the memory of personnel, such as a chief engineer or staff electrician, for example, who may be familiar (in varying degrees) with the systems involved.

The modeling of facilities of the type with which the present invention may be used is often accomplished manually. Such facilities may include new construction or existing structures. Personnel utilize “as built” drawings of varying quality. Such drawings are static in nature. Important information is often not organized properly. Their use requires time to retrieve them as well as to interpret them. And, importantly, their manual use introduces human error into the equation.

Personnel utilizing existing, state of the art procedures require training. The drawings just described are often used in training programs. Standardized operating procedures for particular facilities are introduced to those being trained, which often include a number of trainees gathered together in a training room, or the like. The trainees are shown drawings in physical or electronic form, and they are then introduced to the equipment and systems by being shown the equipment.

Once trained, personnel use operating procedures which typically include reviewing infrastructure, with a view toward maintenance, or modifying existing equipment, or installing new equipment, as part of capital improvement projects. Such procedures require a degree of advance planning, to allow and compensate for shutdowns or other types of maintenance, construction or expansion operations. A facilities manager normally plans and oversees maintenance shutdowns of mechanical, electrical and/or plumbing systems within a facility. He or she will review diagrams and drawings, such as riser diagrams and floor plans, with a view toward identifying the equipment to be involved. Importantly, any such shutdown will directly and indirectly affect equipment and systems which may not be the equipment or facilities to be maintained or worked on. The possibility of human error is introduced here, where the equipment indirectly affected by the shutdown is identified, such as by its being highlighted on physical paper or velum drawings.

In any kind of facility of the type identified herein, there is a possibility of equipment failure. Such failures are unplanned events which occur at any time of day or night. These equipment failures have the capacity to significantly interrupt the normal operation of the facility itself, and will impact the inhabitants, tenants or occupants of the facility. These will include tenants in an office building, or patients and care givers in a hospital or nursing home, or workers in a warehouse, or students and teachers within an educational facility, or prisoners and guards within a penal institution.

Failures of the type just described may involve not merely local disruptions, but remote disruptions, as well. The overall impact of the failure must be quickly and reliably evaluated and understood if people and equipment are to be protected. Alternative modes of redundant operation may be substituted, but only once the impact is fully understood, and this may take considerable amount of time if it is not thoroughly planned for and easily implemented. Time is of the essence and human life may be impacted. The current state of the art does not allow for desired ease, understanding, rapid evaluation, and action of the type needed.

The building modeling system according to the present invention, in a number of respects, virtually eliminates prior art and existing state of the art problems and recurring aggravating “headaches” encountered with current systems known to the art, and provides advantages and easy-to-use tools for the user in relatively large buildings.

By way of example only, in current state of the art buildings, when electricity, HVAC, fire protection or plumbing systems are turned off for safety or maintenance purposes, one is unable to quickly and easily have a mental and visual picture of the effects such a shutdown might have, and which portions of a floor or floors in a building will be affected by the shutdown. Thus, the owner or operator of the building is not in a position to alert and warn tenants and/or occupants in a building who will be affected by a shutdown, that such a shutdown is about to occur. This prevents such tenants and occupants to prepare.

There has long been a significant need for better and more cost and time efficient methods of accomplishing the facility procedures described above. The present invention seeks to accomplish this utilizing a customizable interactive inventive system and methods for graphically depicting for the user complex facility operations and building systems. The terms “smart riser” and “smart single line” have been coined as a trademark by the inventors of the present invention to identify an intuitive, easy to use graphical user interface capable of use to dynamically navigate in real time. The present invention allows for an interactive exchange of instructions and feedback between the user and the inventive system. The system according to the present invention is relatively “intelligent” in that it incorporates information and knowledge about the facility involved, which originated with designers, planners and operators. A complex building system or facility is modeled, using the present invention. Users are able to immediately identify and act upon various modes of operation, thereby speeding the processes of evaluation, decision-making, and implementation. Emergency response times are greatly reduced. Business discontinuity is eliminated or reduced.

### BRIEF DESCRIPTION OF THE DRAWINGS/FIGURES

FIG. 1 is a captured screen shot of an elevation view of main utility switchboards A and B in a facility serviced by the present invention;

FIG. 2 is an enlarged view of a portion of FIG. 1, in which the switches of utility switchboards are shown, labeled;

FIG. 3 is a schematic view illustrating risers in the building of FIG. 1;

FIG. 4 is a schematic plan view of a floor in the building of FIG. 1;

FIG. 5 is a view similar to FIG. 1, illustrating a scenario where Util-A main switch has been thrown;

FIG. 6 is an enlarged view of a legend portion of FIG. 5 in which a figurative outline of the building of FIG. 1 is shaded in blue to indicate the part of the building affected by throwing Util-A main switch;

FIG. 7 is an enlarged view of a portion of FIG. 5, in which the switches are shown in their respective positions after Util-A main switch has been thrown showing loss of power to all switches in blue and indicating which switches are served by emergency sources in red;

FIG. 8 is a plan view similar to FIG. 4, illustrating with blue shading the portion of the floor affected by the Util-A main switch being thrown;

FIG. 9 is a view similar to FIG. 1, illustrating a scenario where switch UPSA has been thrown, the red indicates load is served by an emergency source;

FIG. 10 is an enlarged view similar to FIG. 2, in which switch UPSA has been thrown;

FIG. 11 is a partial enlarged view of a riser illustration, in which the portions of the risers affected by switch UPSA being thrown are shown in red and the loss of power to the normal circuit shown in blue;

FIG. 12 is another partial enlarged view of the riser illustration of FIG. 11, focusing upon the upper left portion of that view;

FIG. 13 is a view similar to FIG. 1, illustrating a scenario where switch BD-A4 has been thrown;

FIG. 14 is a view similar to FIG. 3, wherein the portions of the risers affected by switch BD-A4 being thrown are shaded in blue; and

FIG. 15 is a plan view similar to FIG. 4, illustrating with blue shading the portion of the floor affected by the switch BD-A4 being thrown.

### DETAILED DESCRIPTION OF THE INVENTION

### Discussion

The present invention overcomes each and every problem mentioned above, by providing a customizable interactive building modeling system capable of graphically depicting mechanical, electrical, plumbing and fire protection (MEPFP) systems of complex facility operations in buildings such as, without limitation, hospitals, commercial buildings, industrial buildings, residential buildings, educational buildings, entertainment complexes, data centers, large warehouses, large nursing homes, recreational centers, penal facilities, and governmental and other facilities, wherein the user is able to utilize a graphic user interface with portable and battery operated devices, such as tablets and smartphones.

The following describes the types of facilities and systems with which the present invention can be associated. Challenges that face owners and operators of such facilities create opportunities for the present invention to alleviate and solve exiting problems throughout the industry.

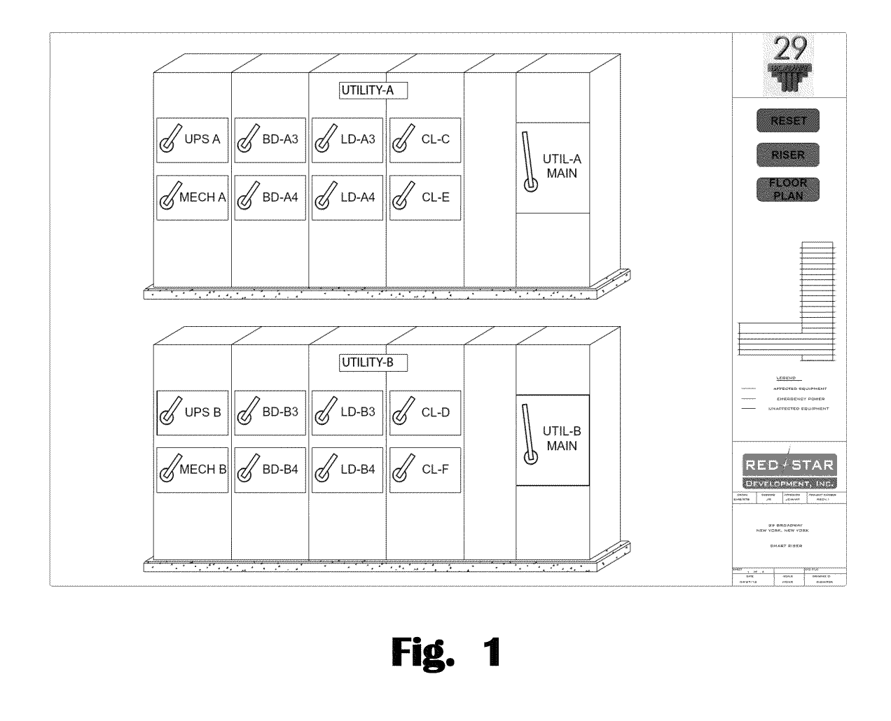

An electrical distribution system is the installed equipment that provides for the distribution of electrical wiring throughout the facility. It normally includes a main switchboard of the type schematically shown in FIG. 1, which receives power from the serving utility. Associated equipment and components include switches, cable risers, bus duct risers, panel boards, motor controllers, and motor control systems, shown in the drawings, for distribution of electricity throughout the facility.

Many facilities utilize uninterruptible power supply (UPS) systems, with or without emergency power generators, illustrated in the drawings. The UPS systems and emergency power generators supply backup electricity in the event the facility experiences a utility power outage. In such instances, power is switched over from the utility power source to the emergency power source by means of an automatic transfer switch (ATS). Once utility power is restored, power is switch back.

Mechanical distribution systems in facilities of the type mentioned here comprise installed equipment that provides for the distribution of heating and cooling throughout the facility. A typical cooling system will include chillers, chilled water piping and valves, pumps to move the cooling medium, and air handling units (AHUs) to absorb heat and to distribute cooling to the facility. Such systems often include cooling towers and associated condenser water piping, valves and pumps to reject heat from the space to the outdoor environment. Centrally located air handling systems often service multiple regions or floors of a building and provide conditioned air to theses spaces. These systems would include the air handling unit itself, as well as ductwork for distribution and dampers for control. While these components are classified as mechanical, most require electricity in order to function properly.

Plumbing and fire protection systems are similar in nature and requirements as the mechanical and electrical systems just described. Plumbing systems would include hot/cold water piping and sanitary/vent piping, as well as associated system valves to control flow. Fire protection systems would include gaseous systems, pre-action systems, and stand-pipe and sprinkler piping. Similar to plumbing systems, the fire protection systems include piping and valves (automatic control valves and manually controlled valves) to control flow.

The subject facility's MEPFP infrastructure is documented by means of drawings created using a computer aided drafting (CAD) program of either a proprietary design or one that is commercially available, such as AutoCAD, Archimedes, or ProEngineer. The images are viewable either by printing on paper or other medium, or are viewed on the monitor of the computer using the CAD program or in Portable Document Format (PDF). This is a two or three-dimensional view which has no easy way of seeing isolated portions of the infrastructure distribution systems.

The MEPFP infrastructure drawings are used by facility managers for planning, day-to-day operations and emergency situations. Presently, without the aid of the present invention, facility personnel and management will rely upon paper drawings, highlight markers and verbal communications to complete their tasks. Such events include, but are not limited to, what are referred to herein as Planned MEPFP Shutdowns and Unplanned MEPFP Shutdowns.

In a planned MEPFP shutdown, the current job of a facility manager involves maintaining the electrical and mechanical infrastructure of the building. The manager will frequently plan a shutdown of particular areas of the building in order to inspect, test, maintain, and/or modify existing and new equipment. The planning for this event requires accurate documentation identifying the equipment which will be affected and those users who will have a periodic interruption to their normal business activities. It also requires the facility manager to outline a plan to shutdown each of the numerous components of the infrastructure in a safe and orderly process. Upon completing maintenance, the engineering team would need to restore all components of the infrastructure. This information is often obtained by using a paper print out of a building equipment riser or an electronic version that cannot be modified. Typically, facility managers find the documentation to exist in an unorganized array of multiple forms that need to be pieced together to understand the facility as a whole. The facility manager would need to manually find and document all components affected based on the drawing provided. Each floor would need to be evaluated manually to determine which areas and which tenants will be affected. This process can be very time consuming and is subject to human error, causing many wasted hours in planning the shutdown.

In an unplanned MEPFP shutdown, mechanical and electrical equipment failures represent the concern for a facility manager. Unplanned events interrupt normal operation of a building, and the facility manager is required to quickly and as efficiently as possible determine the source of the problem and come up with a solution to the problem. In order to determine the problem, the engineer or engineering team is deployed to the incident to gather information and evidence to determine the problem's root cause. Notification that an incident is occurring often arrives from a tenant who notifies the building's management, or it may come from an alarm received from a monitoring point.

Currently, the state of the art provides for alarm notifications which only display the status of certain conditions, not the overall effect and impact of the problem causing the alarm. It is the facility manager's responsibility to determine what caused the alarm to be triggered and the affected area. The manager must notify the affected users/tenants, and plan the restoration process. In order to determine the cause, it is essential to have accurate drawings in order to see all of the potentially affected areas. This information is often obtained by using a paper print illustrating a building's equipment riser, or an electronic version that cannot be modified in real time. Additionally, in many instances the facility manager relies upon the memory of the facilities' chief engineer and/or electrician, who may or may not be physically located at the facility during the incident triggering the alarm. The facility manager would need to manually find and document all components affected based upon the drawing provided.

The facility manager must also notify the users/tenants of the events that have occurred, in order to protect life and property. Each floor of a facility would need to be evaluated manually to determine which areas and which tenants were affected. The engineering team will need to inspect areas that could potentially be affected or which might be the cause of the event. Determining the affected groups would involve reviewing numerous documents in the form of floor plans and equipment risers, and manually finding the affected areas.

Properly planning the restoration process requires knowledge and proper documentation of the building's emergency infrastructure. This documentation is normally a paper source or an unchangeable electronic file. In order to devise the restoration process, the facility manager will need to manually find and record all emergency devices that have been activated. Thereafter this manager attempts to determine how to proceed in solving the issue. These processes can be very time consuming and is subject to human error.

A hypothetical example of an unplanned shutdown might include a terrorist attack on the north side of a building. The electrical switchboard on that side of the building may, for example, be impacted by the attack. As a result, many different parts of the building may experience a direct power outage as a result of the attack; however, the entire building may not be powerless. Another example might involve a technician working on a piece of equipment and who accidentally causes a ground fault, resulting in a particular switchboard's main switch being tripped by ground fault overcurrent. This can result in one switchboard losing power, while the remainder of the building is still able to utilize utility power during the period the impacted switchboard is not providing power.

According to the present invention, a customizable interactive system and method is provided which graphically depicts complex facilities and their operation. The facility is modeled on a computer screen or on a portable device such as a tablet or smartphone. Mechanical and electrical systems associated with high-rise buildings provide an excellent environment for the present invention. Personnel involved in building management are able to quickly see the results of alternative modes of operations, thus speeding the iterative process of decision-making. Furthermore, when mechanical or electrical components fail, the present invention facilitates rapid emergency response and supports business continuity efforts. The complicated task of navigating through documentation of what may be an enormous number of components in a building's distribution system is greatly simplified by use of the present invention. The present invention provides an easy to use tool and system for the analysis, design and operation of MEPFP Infrastructure Systems. It is applicable to, for example, electrical systems and HVAC systems. The invention enables the user to select an MEPFP component in a facility drawing by clicking on it to simulate a power outage. The impacted portion of the electrical distribution is automatically highlighted in shading or a different color on an associated riser diagram, while another screen is available to the user in the form of a floor plan, which is similarly automatically highlighted in shading or a different color to show affected areas for lighting and power. Yet another screen is provided which highlights areas in which the HVAC will be impacted by the power outage. Thus, one sees that the present invention provides a novel system, methods, apparatus, and a computer-readable medium embodying software for performing the methods and enabling processing and modification of CAD drawings or PDFs to illustrate or depict to the user the impacted equipment and/or areas. This is automated, including the selection and depiction of objects, such as electrical risers and equipment, throughout the CAD drawing or PDF.

The present invention contemplates its being an add-on feature for existing software programs written or stand-alone application, by way of example only, in JavaScript, Visual Basic, Visual Basic for Applications, Java, or .NET, ActionScript, Flash, HTML5). The invention further contemplates its operating as a standalone system, such as, without limitation in conjunction with the AutoCAD platform available from Autodesk, Inc., or any other CAD-type or PDF program Can also be a web-based application, allowing access via a web browser. Can also be a mobile application or desktop software installed directly on mobile or desktop hardware.

A feature of the present invention is its being backward operational and compatible. For example, by clicking on a component on a floor plan depiction of a facility's system (i.e. an electrical panel board) or, for example, a user's workstation, that component will be highlighted or shaded, as will the complete power distribution back to the source at the main switchboard.

Yet another feature of the present invention resides in its use with electrical sub-metering. Many facilities have multiple tenants, which requires the use of multiple sub-meters for electrical metering. The process of sub-metering can be simplified with the use of the present invention, by virtue of its use as a quick visual aid lin identifying those building loads and sub-meters associated with a particular tenant.

When used in planning a new or expanding an MEPFP infrastructure system, the invention may be used to insure proper coverage, show single point of failures and insure redundancy. Day-to-day operations may be helped with the invention via building personnel being able to use the system as part of a response to tenant/user trouble calls and to identify possible failure points, before investing the time to physically go to the area in question. Printouts of the affected or questioned are easily created, to aid building personnel in locating problem.

During emergency operations, building personnel using the present invention are able to access on a computer or table screen the areas of interest in order to coordinate an appropriate emergency response, as well as to transmit system status to remote locations so that offsite personnel will be able to view electronic drawings of failed or impacted sections of infrastructure. This permits rapid and more efficient assessments of the impact of problem upon the facility, as well as to coordinate repairs. This permits the sharing of especially important knowledge and information with others involved in decision making and responding.

Referring to the drawings, FIGS. 1 through 4 illustrate a condition where there is no problem associated with the facilities serviced by the present invention.

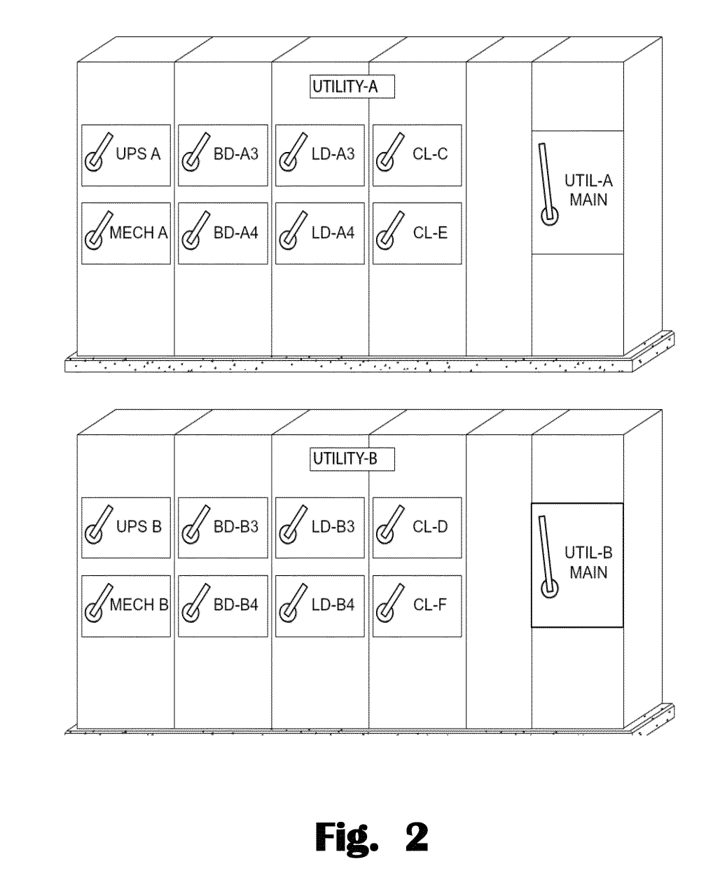

FIG. 1 illustrates a captured computer screen shot of an elevation view of main utility switchboards A and B in a facility serviced by the present invention. Utility A and B switchboards are shown, with schematic representations of main switches and circuit breakers. FIG. 1 illustrates distribution switches and circuit breakers, as well as affected components. FIG. 2 is an enlarged view of a portion of FIG. 1, in which the switches of utility switchboards are shown, labeled.

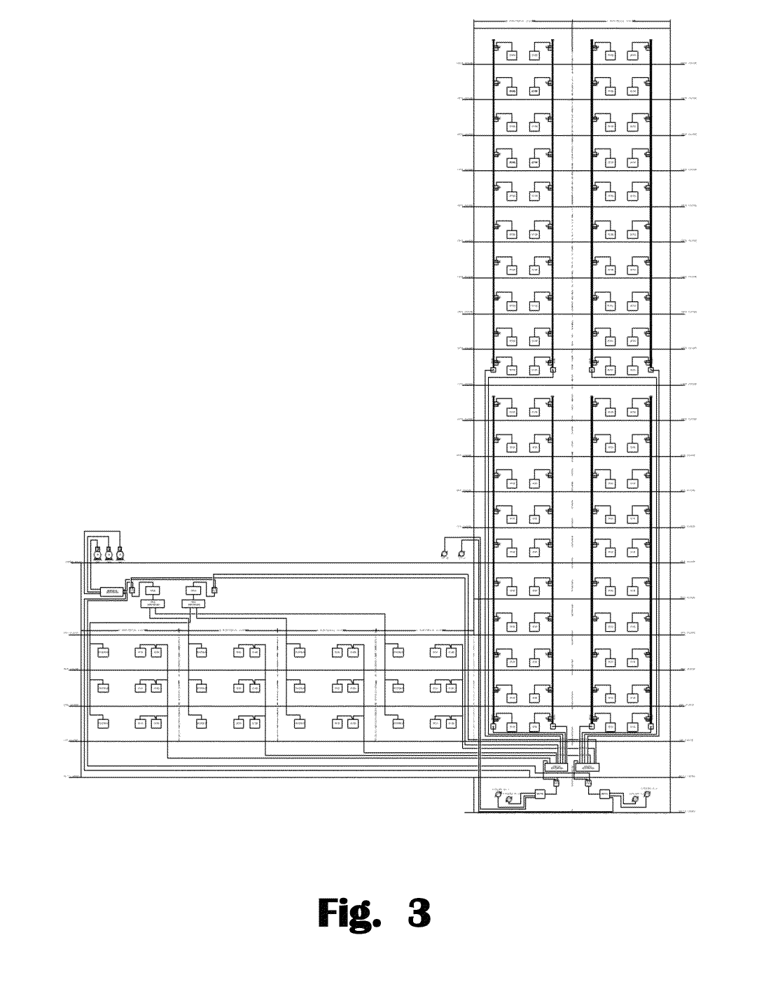

FIG. 3, in a schematic view, attempts to illustrate in schematic fashion the risers in the building of FIG. 1. Risers will have associated with them and will be connected with a switchboard, a generator, an uninterruptable power supply, an automatic transfer switch, cable risers, bus duct risers, panel boards, chillers, at least one cooling tower, a condenser, a chilled water pump, an air handling unit, and other components.

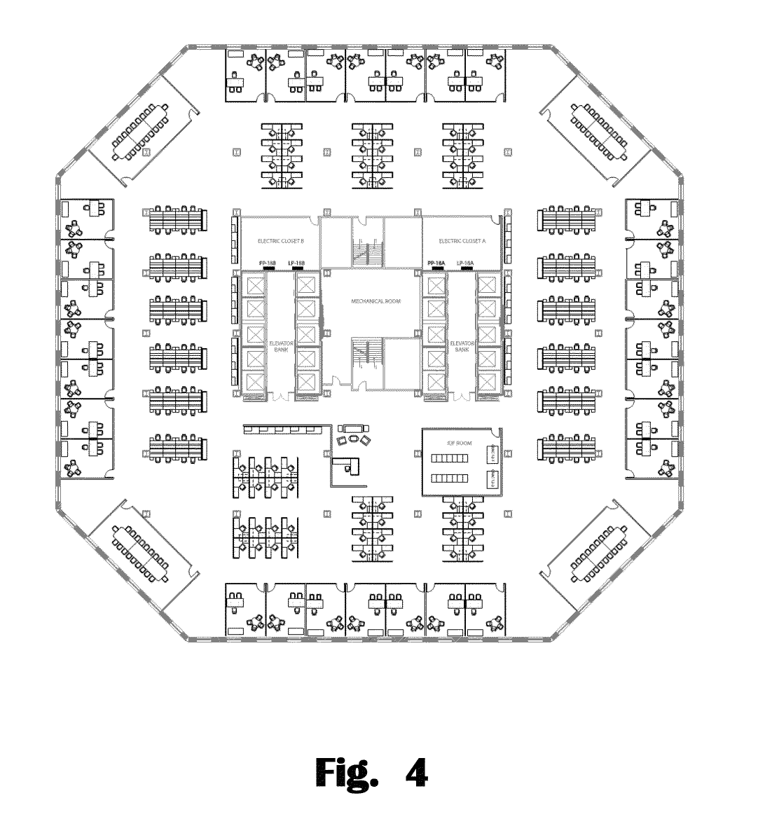

FIG. 4 is a schematic plan view of a floor in the building of FIG. 1. A typical floor plan may include a bus duct riser, a utility power panel board, a UPS power panel board, an information technology (IT) equipment room, IT equipment, open area workstations, perimeter offices, trading desks, a computer room air conditioner, an air handling unit, a fan powered box, and lighting fixtures.

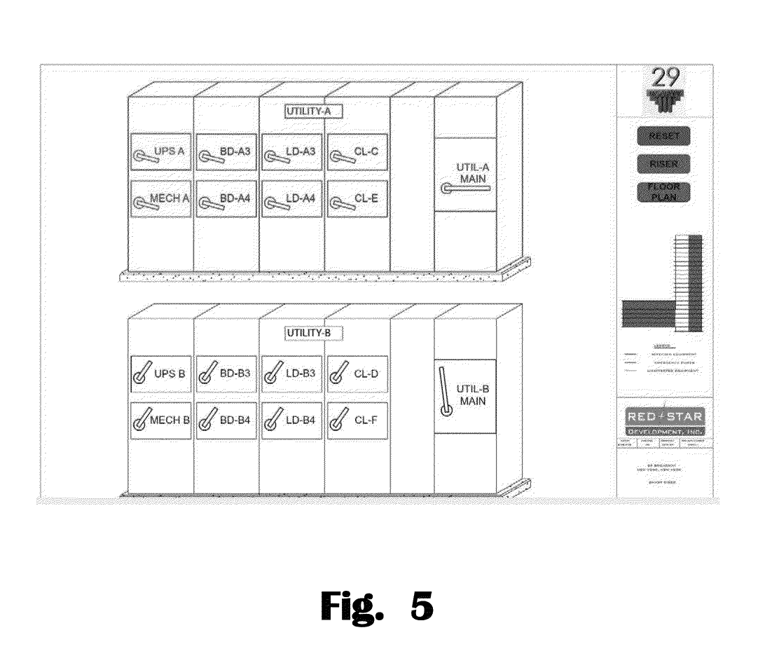

FIGS. 5 through 8 are intended to illustrate the use of the present invention where a main electrical utility switch is thrown, and the depicted effects upon associated system components. In FIG. 5, which is a view similar to FIG. 1, by placing the cursor over the Util-A main switch and clicking, using the present invention, the user is able to figuratively but effectively illustrate “throw” that switch from an “on” position to an “off” position. FIG. 5 illustrates such a scenario where Util-A main switch has been thrown. The reader's attention is drawn to the change in color and the change to the thrown position of all of the switches associated with Utility A, as a direct result of throwing the main switch. The system according to the present invention accomplishes this for the benefit of the user, so that the user is able to see the effect of throwing the main switch A.

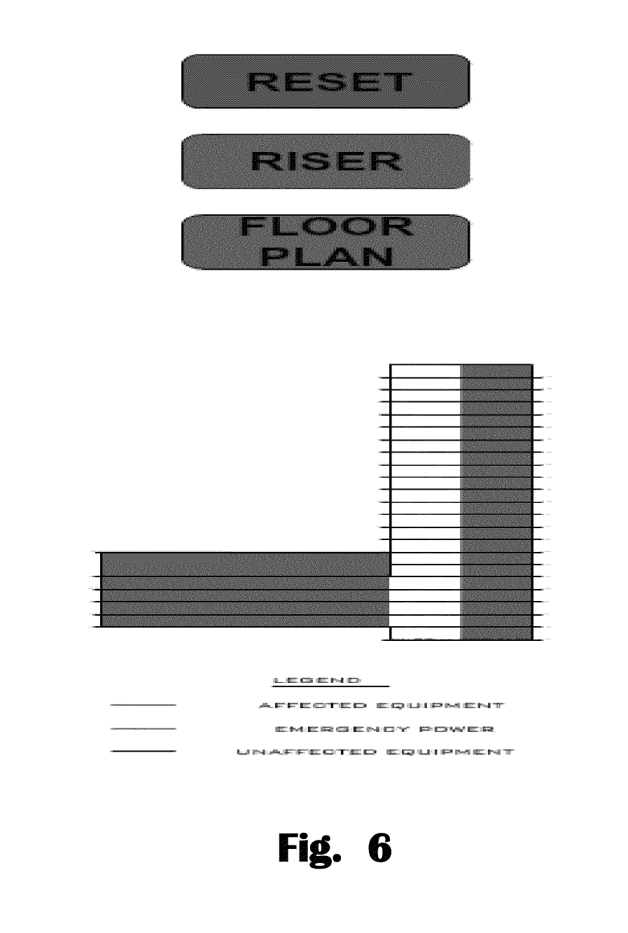

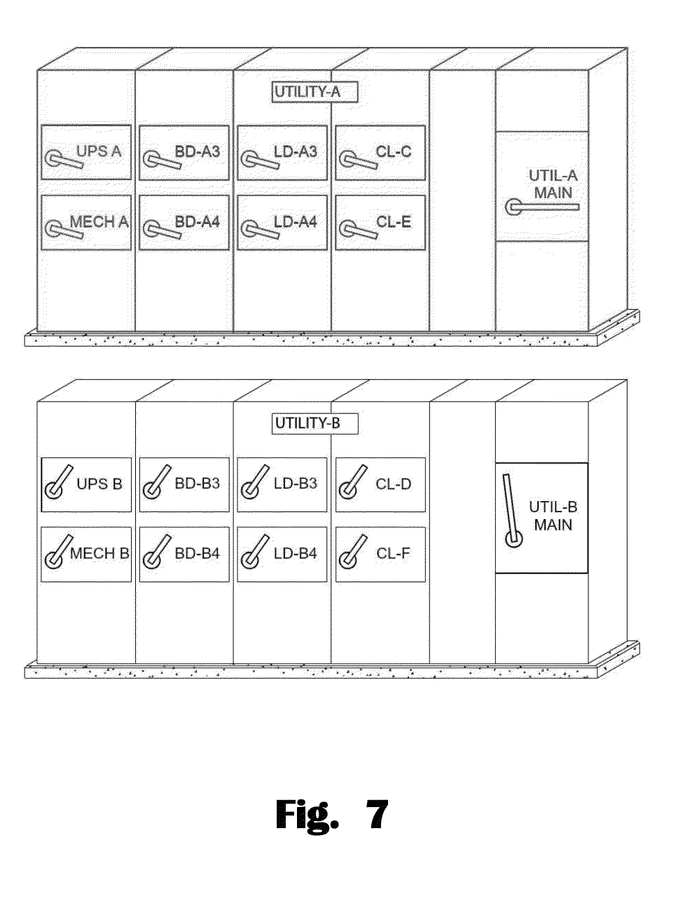

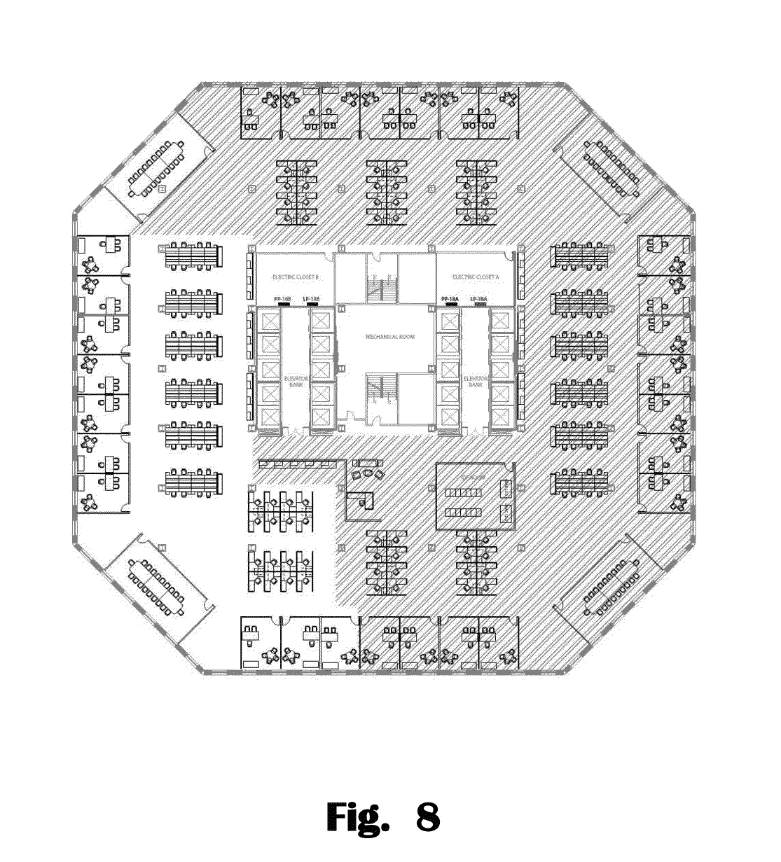

The reader's attention is also drawn to the legend box on the right side of FIG. 5, wherein a small figurative representation of the building involved has been shaded in blue to indicate that part of the building affected by thrown switch Util-A. FIG. 6 is an enlarged view of that legend portion. Similarly, FIG. 7 is an enlarged view of a portion of FIG. 5, in which the switches are shown in their respective positions after Util-A main switch has been thrown. FIG. 8 is a plan view similar to FIG. 4, illustrating with blue shading the portion of the floor affected by the Util-A main switch being thrown;

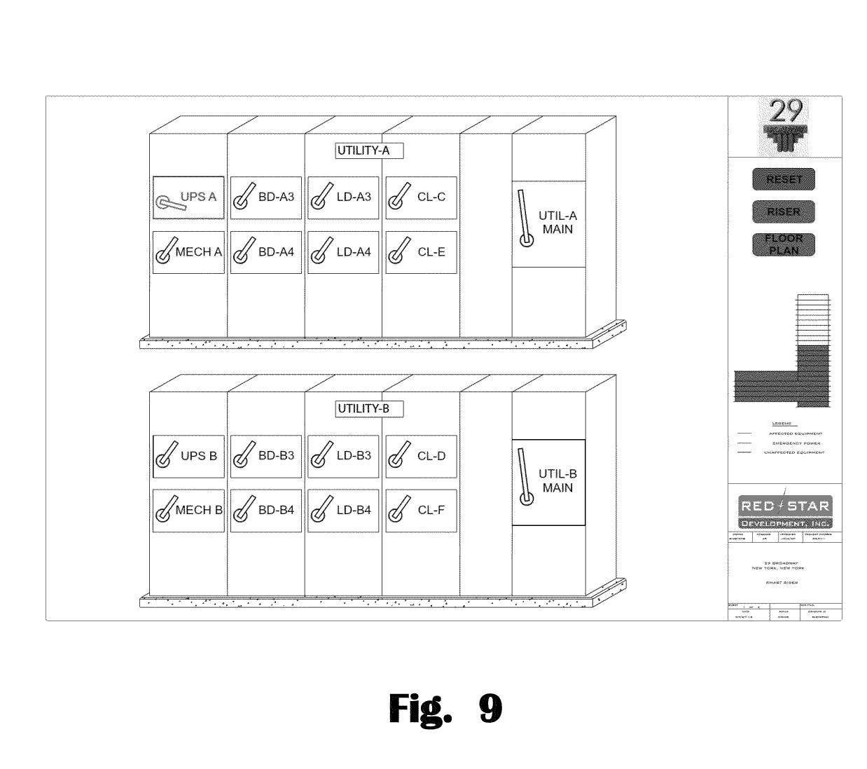

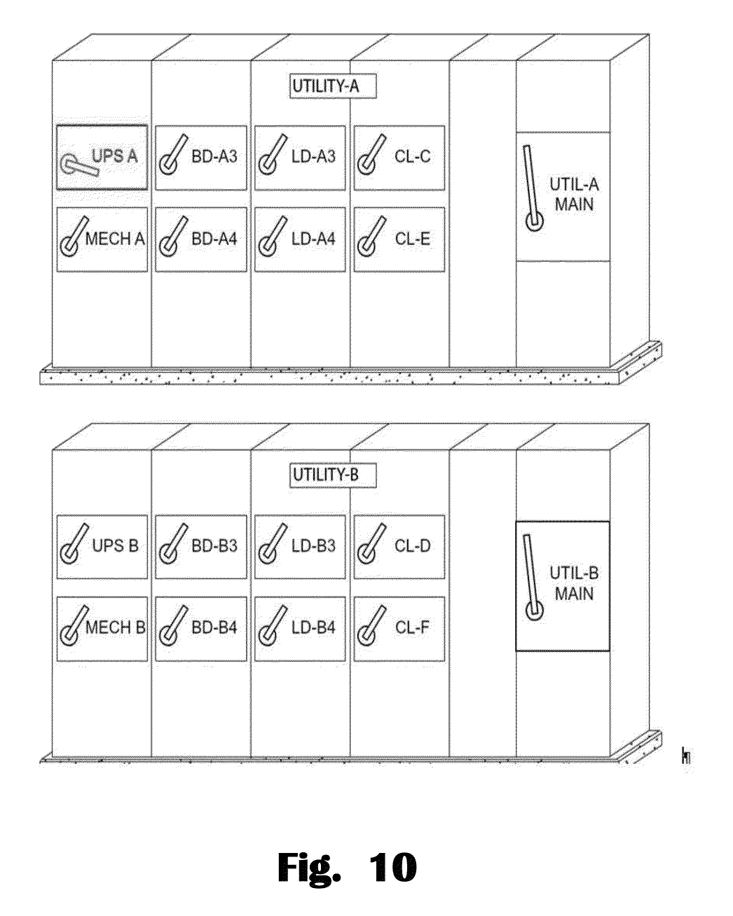

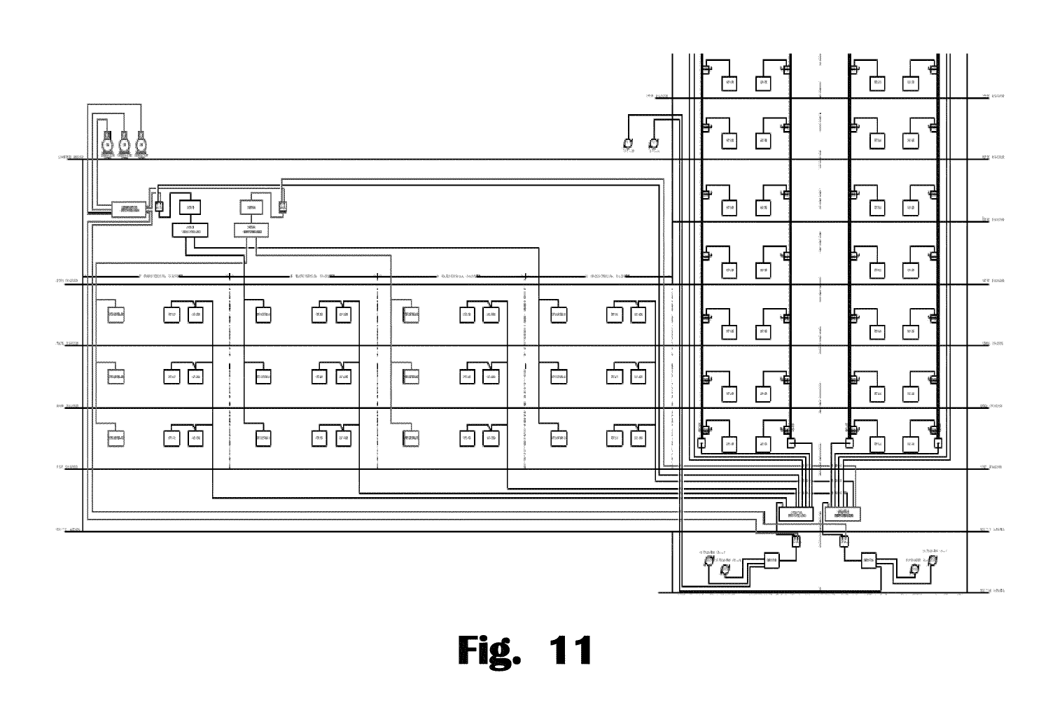

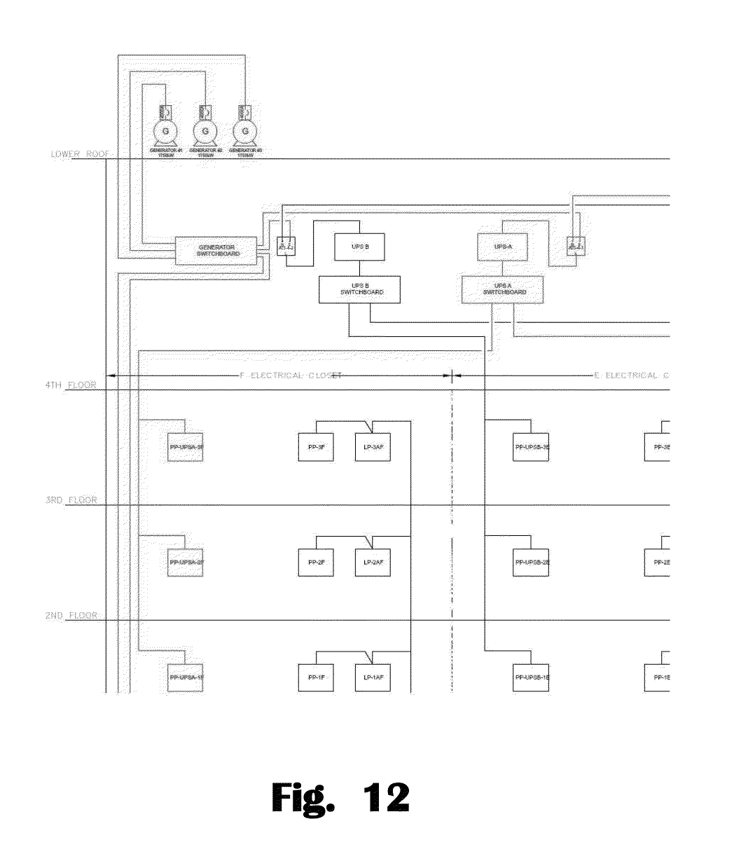

FIGS. 9 through 12 are presented to illustrate the use of the present invention where switch UPSA is thrown, and the depicted effects upon associated system components. FIG. 9 is a view similar to FIG. 1, illustrating a scenario where switch UPSA has been thrown. FIG. 10 is an enlarged view similar to FIG. 2, in which switch UPSA is illustrated as having been thrown. FIG. 11 is a partial enlarged view of a riser illustration, in which the portions of the risers affected by switch UPSA being thrown are shown in red. FIG. 12 is another partial enlarged view of the riser illustration of FIG. 11, focusing upon the upper left portion of that view.

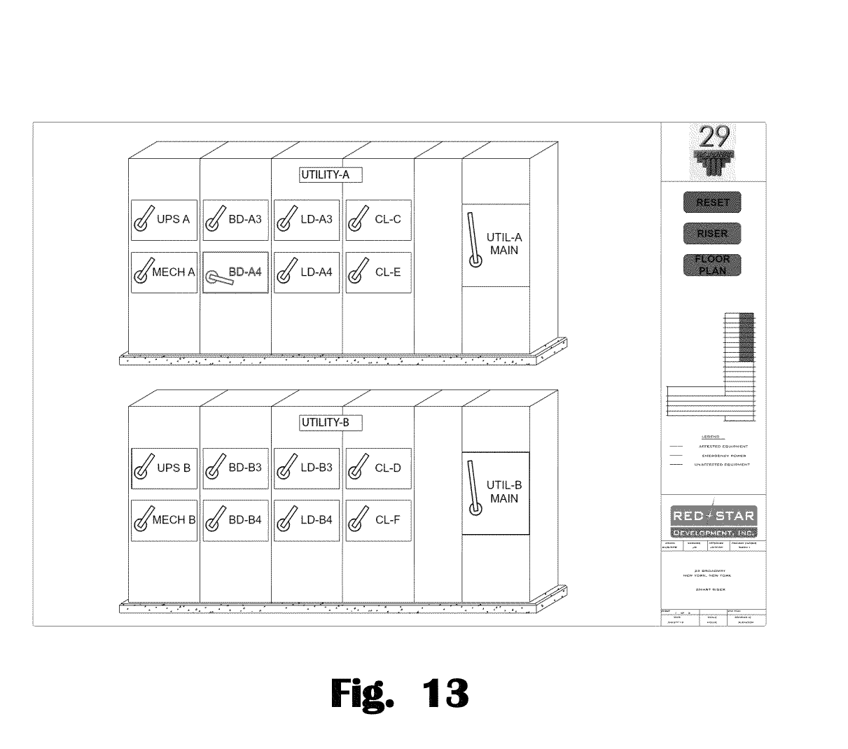

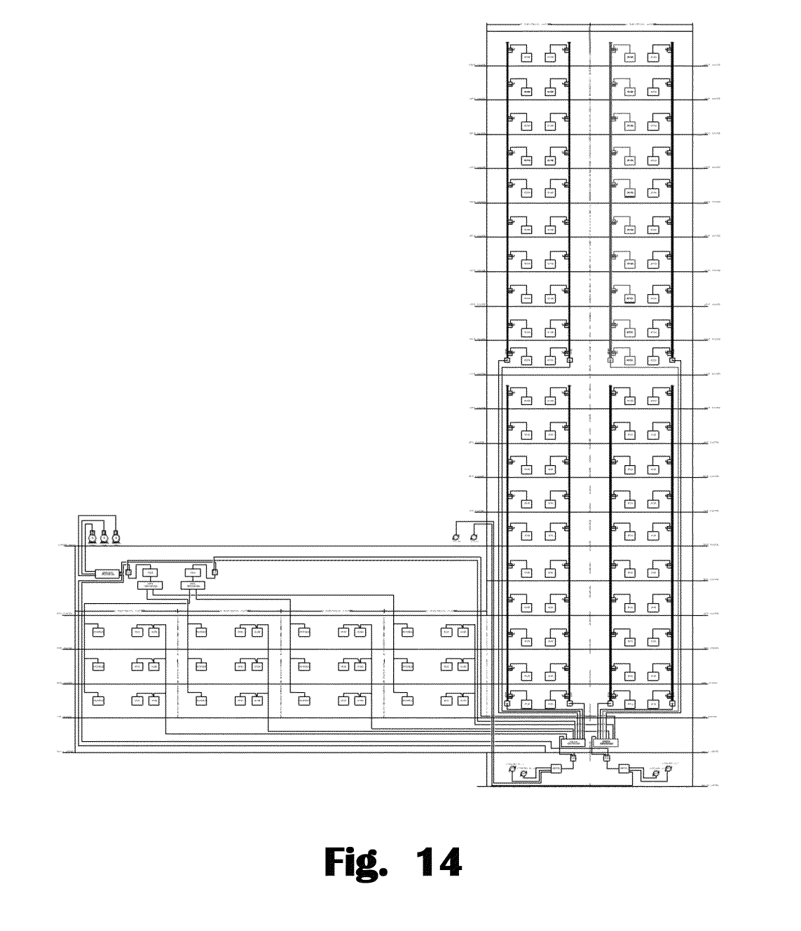

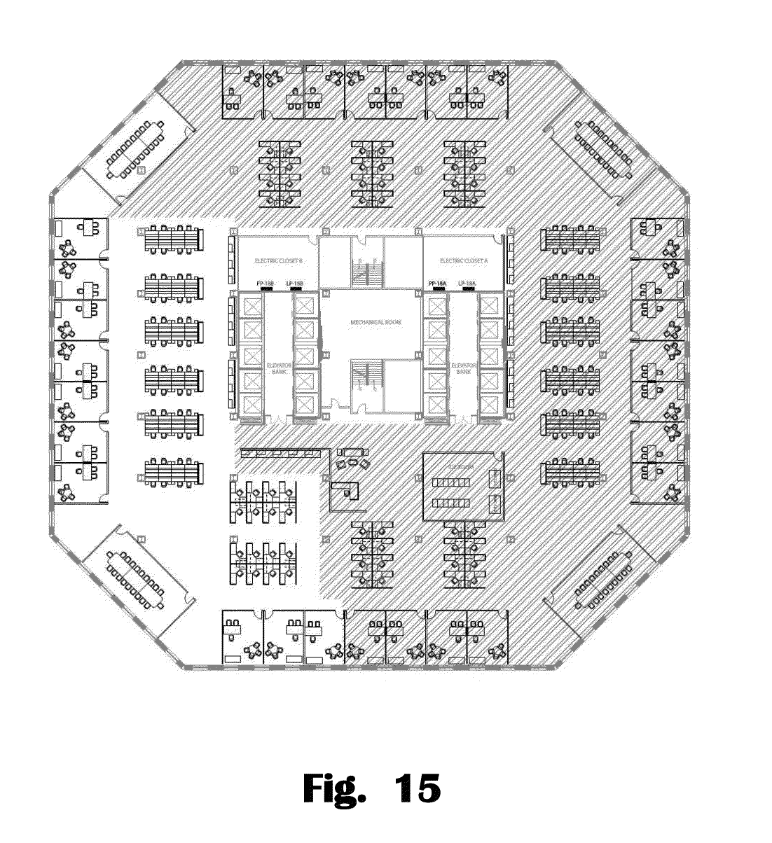

To further illustrate how the present invention can be used, FIGS. 13 through 15 are presented to illustrate a scenario in which switch BD-A4 is thrown, using the cursor and clicking on that switch on the elevation view. Thus, FIG. 13 is a view similar to FIG. 1, illustrating that scenario where switch BD-A4 has been thrown. FIG. 14 is a view similar to FIG. 3, wherein the portions of the risers affected by switch BD-A4 being thrown are shaded in blue. FIG. 15 is a plan view similar to FIG. 4, illustrating with blue shading the portion of the floor affected by the switch BD-A4 being thrown.

We thus see that the present invention provides a user friendly, interactive display that quickly illustrates changes in the building environment resulting from the activation of buttons on the display, to simulate real life events. As has been stated, an important feature of the invention resides in its being forward/backward interactive, thereby permitting user to interact with the invention's display, to change the state of components and visually see in an instant the resulting state of the facility's system.

The invention provides a far faster response capability for planning and emergencies than can be enjoyed by the current state of the art. It can act as consolidated database of essential facility information, which is electronically backed up, reduces human error, provides printouts upon demand, and can be secured with password protection. The invention contemplates the use of “cloud computing” to provide easily accessible data without relying upon fixed on-site servers which may become damaged. The Invention also contemplates the ability to be connected to said MEPFP infrastructure equipment, either directly or via Electrical or Building Monitoring System, to acquire equipment status as the input rather than user-provided on the input screen. This would thus provide a “live-view” of impacted equipment/regions of a facility.

### CONCLUSION

The novel invention of the present invention comprises a customizable interactive building modeling system capable of graphically depicting mechanical, electrical, plumbing and fire protection (MEPFP) systems of complex facility operations in buildings such as, without limitation, hospitals, commercial buildings, industrial buildings, residential buildings, educational buildings, entertainment complexes, data centers, large warehouses, large nursing homes, recreational centers, penal facilities, and governmental and other facilities, wherein the user is able to utilize a graphic user interface with portable and battery operated devices, such as tablets and smartphones.

We see that the present invention has favorable attributes described above and which include, without limitation, use in connection with the following:
Facilities (defined above) such as manufacturing plants, office buildings, data centers, hospitals, etc.
Power outages with and without backup power
MEPFP single point of failure analysis
Power system design and/or expansion
HVAC equipment failures, shutdowns or design
Fire protection and fire suppression system failures or design
Sub-tenant metering for landlords and building owners
Use with tablets, smartphones and other portable devices.
Standalone applications
Web-based applications
Telecommunications environments
Water leaks, where plumbing problems become electrical problems
Applications where power to the entire building need not be shut off
Older buildings where electrical insulation has deteriorated
Instantaneous identification of the location where repair is needed
Safety enhancement
Mission critical environments, including hospitals and data centers where equipment will include MRIs, X-ray, life support, oxygen making machines, radiation machines, occupational therapy systems, physical therapy equipment, patient monitoring, critical surgery lighting, records access, etc.
Aid to firefighters entering a building
Use with maintenance procedures where infrared tools detect hot switches
Better tenant/user relations through early courtesy notifications
Forward and backward capability

This invention contemplates variations and other embodiments coming within the spirit and scope of our invention, and it is not to be improperly or unduly limited.

The present invention further contemplates uses in what are referred to as “complex facilities” such as, without limitation, facilities which include educational and commercial campuses, as well as governmental, commercial and residential infrastructures.

The following invention is claimed:

1. A customizable interactive building modeling system capable of graphically depicting mechanical, electrical, plumbing and fire protection (MEPFP) systems of complex facility operations in buildings such as, without limitation, hospitals, commercial buildings, industrial buildings, residential buildings, educational buildings, entertainment complexes, data centers, large warehouses, large nursing homes, recreational centers, penal facilities, and governmental and other facilities, wherein the user is able to utilize a graphic user interface with portable and battery operated devices, such as laptops, tablets and smartphones.
